(19) United States
(12) Patent Application Publication
(10) Pub. No.: US 2015/0273731 A1
(43) Pub. Date: Oct. 1, 2015

(54) METHOD AND DEVICE FOR IMPLEMENTING MECHANICAL, CHEMICAL AND/OR THERMAL PROCESSES

(71) Applicant: LIST HOLDING AG, Arisdorf (CH)

(72) Inventors: Pierre-Alain Fleury, Ramlinsburg (CH); Daniel Witte, Grenzach-Wyhlen (DE); Roland Kunkel, Frankfurt a.M. (DE); Alfred Kunz, Muttenz (CH); Pierre Liechti, Muttenz (CH)

(73) Assignee: LIST HOLDING AG, Arisdorf (CH)

(21) Appl. No.: 14/431,650

(22) PCT Filed: Sep. 26, 2013
(86) PCT No.: PCT/EP2013/070141

§ 371 Date: Mar. 26, 2015

(30) Foreign Application Priority Data
Sep. 28, 2012 (DE) 10 2012 109 259.1
Jan. 9, 2013 (DE) 10 2013 100 182.3

(51) Int. Cl. B29B 7/24; B01J 19/18; B29B 7/82; B01J 19/00; B29B 7/60; B29B 7/80

(52) U.S. Cl. CPC B29B 7/24; B29B 7/60; B29B 7/802; B29B 7/82; B01J 19/006; B01J 19/18; B01J 2219/00765

(57) ABSTRACT

A method for implementing mechanical, chemical and/or thermal processes in a product which is located in a housing (1) with mixing and cleaning elements and/or transporting elements (6) on at least one shaft (4, 5), and is transported via the elements (6) from an inlet (2) to an output (10), the intention is for a cross section of the housing (1) to be adjusted in variable fashion at least in the longitudinal direction thereof.

### BACKGROUND OF THE INVENTION

The invention relates to a kneader mixer for implementing mechanical, chemical and/or thermal processes in a product that is located in a housing with mixing and cleaning elements and/or transport elements on at least one shaft, and is transportable via these elements from an inlet to an output.

Devices of such kind are called kneader mixers. They are used in a very wide range of applications. Firstly, they are used for vaporizing with solvent recovery, which is carried out in batches or in continuous operation, often in a vacuum as well. In this way, distillation residues are treated, for example, particularly toluene diisocyanates, but also production residues with toxic or high boiling solvents from the chemical industry and pharmaceutical production, washing solutions and paint sludges, polymer solutions, elastomer solutions from solvent polymerization, adhesives and sealing compounds.

The devices are further used to carry out contact drying of products that are wet with water and/or solvents in continuous or batch mode, often also in a vacuum. The application is intended mainly for pigments, dyes, fine chemicals, additives such as salts, oxides, hydroxides, antioxidants, temperature-sensitive pharmaceutical and vitamin products, active agents, polymers, synthetic rubbers, polymer suspensions, latex, hydrogels, waxes, pesticides and residues from chemical or pharmaceutical production, for example salts, catalysts, slags and waste lyes. These processes are also used in food manufacturing, for example in the production and/or treatment of block milk, sugar substitutes, starch derivatives, alginates for treating industrial sludges, oil sludges, biosludges, paper sludges, paint sludges, and generally to deal with sticky, crust-forming, gelatinous products, waste products and cellulose derivatives.

A polycondensation reaction can take place inside a kneader mixer, usually in continuous mode and usually in the melt, and this is used mainly in the treatment of polyamides, polyesters, polyacetates, polyimides, thermoplastics, elastomers, silicones, urea resins, phenolic resins, detergents and fertilizers. It is applied for example to polymer melts after a bulk polymerization operation on derivatives of methacrylic acid.

A polymerization reaction may also take place, also most often in continuous mode. This is used on polyacrylates, hydrogels, polyols, thermoplastic polymers, elastomers, syndiotactic polystyrene and polyacrylamides.

Kneader mixers may also be used for degassing and/or devolatilizing. This process is used on polymer melts after one or more monomers have been (co)polymerized, after polyester or polyamide melts have been condensed, on spinning solutions for synthetic fibers, and on polymer or elastomer granulates or powders in the solid state.

In general, solid, liquid or multiphase reactions may take place in the kneader mixer. This applies particularly to back reactions when processing hydrofluoric acid, stearates, cyanides, polyphosphates, cyanuric acids, cellulose derivatives, cellulose esters, cellulose ethers, polyacetal resins, sulfanilic acids, Cu phthalocyanins, starch derivatives, ammonium polyphosphates, sulfonates, pesticides and fertilizers.

Additionally, reactions may take place between solid Zgas phases (e.g., carboxylation) or liquid Zgas phases. This is used when treating acetates, acids, Kolbe-Schmitt reactions, e.g., BON, Na salycilates, parahydroxybenzoates and pharmaceutical products.

Liquid/liquid reactions take place during neutralization reactions and transesterification reactions.

A dissolving and/or degassing reaction in kneader mixers of such kind takes place with spinning solutions for synthetic fibers, polyamides, polyesters and celluloses.

A process called “flushing” takes place during the treatment or manufacture of pigments.

Solid state post-condensation takes place during the treatment or manufacture of polyesters, polycarbonates and polyamides, continuous mashing takes place during the treatment of fibers, for example, such as cellulose fibers with solvents, crystallization from the melt or from solutions takes place when treating salts, fine chemicals, polyols, alcoholates, compounding, mixing (continuously and/or in batches) takes place for polymer mixtures, silicone compounds, sealing compounds, flue ash, coagulation (particularly in continuous operation) takes place when treating polymer suspensions.

A kneader mixer may also serve as a container in which multifunctional processes are combined, for example heating, drying, melting, crystallizing, mixing, degassing, reacting—all either continuously or in batch processing mode. Polymers, elastomers, inorganic products, residues, pharmaceutical products, food products and printing inks may be manufactured and processed in this way.

Vacuum sublimation/desublimation may also take place in kneader mixers, as a way to purify chemical precursor materials such as anthraquinone, metal chlorides, ferrocenes, iodine, organometallic compounds, etc. Intermediate pharmaceutical products may also be prepared this way.

Continuous carrier gas desublimation takes place for example with intermediate organic products such as anthraquinone and fine chemicals.

A primary distinction is made between single-shaft and double-shaft kneader mixers. A single-shaft kneader mixer is known for example from AT 334 328, CH 658 798 A5, or CH 686 406 A5. In these cases, a shaft furnished with disk elements is arranged to extend axially inside a housing, and so as to be rotatable in one direction about an axis of rotation. This is what advances the product in the direction of transport. Counter-elements are attached immovably to the housing between the disk elements. The disk elements are arranged in planes perpendicular to the kneading shaft and create free sectors therebetween, which cooperate with the planes of adjacent disk elements to form kneading spaces.

A multishaft mixing and kneading machine is described in CH-A 506 322. In this device, radial disk elements and axially aligned kneading bars between the disks are arranged on one shaft. Framelike mixing and kneading elements from the second shaft engage between the disks. These mixing and kneading elements clean these disks and kneading bars on the first shaft. The kneading bars on both shafts in turn clean the inner wall of the housing.

The disadvantage of these known double-shaft kneader mixers is that because of the eight-shaped housing cross section there is a weak point in the region where the two shaft housings join. In this region, significant stresses are generated when viscous materials are processed and/or in processes that are carried out under pressure, and these stresses can only be managed with expensive design features.

A kneader mixer of the kind described in the preceding text is known for example from EP 0 517 068 B1. In this case, two axially parallel shafts rotate inside a mixer housing in either the same or opposite directions. At the same time, mixing bars mounted on the disk elements interact with each other. Besides their mixing function, a further task of the mixing bars is to clean surfaces of the mixer housing, the shafts and the disk elements with which the product comes into contact as thoroughly as possible, in order to prevent unmixed zones. Particularly with products that become very compacted, hardened or form crusts, the wall effect of the mixing bars gives rise locally to high mechanical loads, on the mixing bars and the shafts. These force peaks occur particularly when the mixing bars engage in those zones where the product cannot readily escape, most of all when the receptacle is very full and especially when the fill level approaches 100% unchecked. Such zones occur where the disk elements are joined to the shaft, for example.

A further kneader mixer of the aforementioned type, in which the bearing elements form a recess in the area of the kneading bars, so that the kneading bar has the greatest possible axial extension, is known from DE 199 40 521 A1. Such a kneader mixer has excellent self-cleaning properties with regard to all surfaces of the housing and the shafts with which the product comes into contact, but on the other hand the bearing elements for the kneading bars render the recesses essential because of the travel paths of the kneading bars, and the shape of the bearing elements has to be complicated. Consequently, this not only necessitates a complex manufacturing process but also leads to local stress peaks at the shaft and the bearing elements under mechanical load, particularly when the fill level approaches 100%. These stress peaks, which occur mainly in the sharp-edged recesses and thickness variations, particularly where the bearing elements are welded onto the shaft core, are responsible for causing cracks in the shaft and the bearing elements due to material fatigue.

EP 2 181 822 A2 describes an extruder with which a housing cross section may be altered approximately centrally between a mixing zone and an extrusion zone.

DE 10 2007 051923 A1 also describes an extruder for processing polymer materials, having a first screw conveyer and a second screw conveyer. Pins are evident, and these may be used to optimize mixing efficiency, particularly depending on the respective material. For this purpose, the position of the pins may changed, or they may be removed.

DE 10 2006 051871 A1 describes a transport device for bulk materials. In this context, the bulk material and liquid are to be mixed together. The mixer contains a shaft with stirring tools. The mixer further comprises a weir disk that is positioned close to the outlet and is mounted so as to be swivelable. The material to be mixed remains inside the mixer depending on the position of the weir disks. In this way, it is possible to set an optimum residence time of the material for mixing in the mixer.

EP 0 438 772 A1 describes a mixer with a container in which a mixing mechanism is arranged. A backflow prevention device in the form of a “weir” is provided in front of the outlet for the mixed material. This backflow prevention device is used to adjust a given fill level of the container, i.e., the height of a bed for the mixing material in the container.

### SUMMARY OF THE INVENTION

An object of the present invention is to better control the fill level of the product between the inlet and the output.

In order to achieve the object of the invention, the device is provided with both an immovable weir and a baffle plate.

The present invention is usable preferably in machines with two shafts. However, the inventive thought is framed in such manner that the invention may also be used in single-shaft or multi-shaft machine applications. The fill quantity itself may be controlled by means of load cells, the present inventions relates primarily to the control of the fill level.

For this purpose, a baffle plate is provided that constricts or enlarges a free cross section of the housing, that is to say a passage, according to the requirement for the product. In this way, the residence time and particularly the fill level and thus also the throughput rate of the product. May be varied by the housing, and in this context of course the processing of the product is also affected (e.g., granulometry). The kneading intensity is controlled and the granulometry of the product is positively influenced by adjusting the baffle plate.

For example, during polymerization a monomer is fed into the kneader mixer and processed. The input may be made in an aggregate fluid state. Under treatment, the product is transformed into an aggregate viscous state as a result of vaporization of solvent or the like, and ultimately may even reach a state that allows granulation. In this context, it may happen that the viscous or pasty phase migrates farther and farther toward the weir, and may then finally also block the passage. The spatial arrangement of this pasty phase inside the kneader mixer may be defined and delimited by adjusting the weir or the passage. This also helps to improve the operating reliability of the kneader mixer. Particularly also with sticky formulations, this movable weir has proven to be extraordinarily valuable. A further advantage is that significantly less crosslinking agents are needed.

This movable baffle plate is preferably located in the area between the housing and the transition to the output, but the inventive concept is intended to encompass other positions in the housing as well.

An immovable weir is allocated to the baffle plate, wherein the baffle plate may be moved along said weir. Of course, the weir itself already narrows the housing cross section somewhat, but also leaves a passage free for the product. The cross section of this passage may then be altered by the movable baffle plate.

The shafts not only pass through the housing itself, but also an adjacent output, wherein additional transport elements are also provided on the shaft in the area of the output and may be able to process the product further as required. In a preferred embodiment in this context, transport elements may be provided that press the product downwards into the output, and/or elements that transport the product back. In this way, clogging of the output is prevented with certainty.

The shaft itself is divided into at least two temperature controlled zones, to which a temperature control medium is fed. The temperature control medium may be at different temperatures, so that one area is intended rather for heating the product up, and another area is intended rather for cooling the product down.

It is further provided that a dedicated exhaust vapor extractor is assigned to the output. The advantage of this is that the product is still surrounded by exhaust vapors even in the output, which acts somewhat as a lubricant for the product, and it is prevented from sticking to the walls of the output.

The absence of any dome/connecting element between the inlet and the output makes it possible for the machine to operate with a controlled high fill level. This is particularly important for comminuting possible lumps. This operating method is referred to as a “lump free process”.

### BRIEF DESCRIPTION OF THE DRAWINGS

Further advantages, features and details of the invention will be evident from the following description of preferred embodiments and with reference to the drawing; in the drawing

FIG. 1 shows a diagrammatic side view of a device according to the invention for implementing mechanical, chemical and/or thermal processes;

FIG. 2 shows a cross section through the device of FIG. 1 along line II-II;

FIGS. 3 to 5 are diagrammatic representations of further possible ways according to the invention to constrict the cross section of the housing of a kneader mixer.

### DETAILED DESCRIPTION

A device P according to the invention for implementing mechanical, chemical and/or thermal processes comprises a housing 1 that has an inlet 2 for a product that is to be treated. Housing 1 may be designed such that it is heatable, and this is provided by specific housing jackets 3 with chambers—not shown in greater detail—through which a heating medium is passed.

The housing itself accommodates two shafts 4, 5, on which mixing and cleaning elements and transport elements 6 are located. Shaft 4/5 extends in direction of transport x. In a preferred embodiment, shaft 4/5 is designed so as to be heatable, wherein two temperature controlled zones are formed, separated by a wall 7 in shaft 4/5. In this way, it is possible to introduce a temperature control medium 8 and/or 9 into the shaft from both sides of shaft 4.

An output 10 is located adjacent to housing 1, and may be furnished with a cooling jacket 11 for example. Shaft 4 also extends through said output 10, where it is furnished with additional transport elements, wherein elements 6.1 and 6.2 are provided and differ from elements 6. Element 6.1 is equipped with a transport bar 12.1 which, unlike a transport bar 12 of elements 6, is positioned at an angle. This means that said transport bar 12.1 and element 6.1 is suited to pressing the product down into the output.

On the other hand, a transport bar 12.2 of element 6.2 is positioned at an angle opposite to transport bar 12 of elements 6, so that it achieves a transport direction for the product, in a direction opposite to transport direction x of transport bars 12. Transport bars 12.2 serve as return kneading bars to relieve the load on the end plate.

In the lower area of output 10, an exhaust vapor extractor 13 is also provided to extract exhaust vapors and/or nitrogen.

A heated/coolable inspection glass 14 is located on top of output 10. Inspection glass 14, which is constructed in the form of a port, is an option to port 13 for recondensing the exhaust vapors (reflux) or for leading the exhaust vapors and/or the nitrogen away.

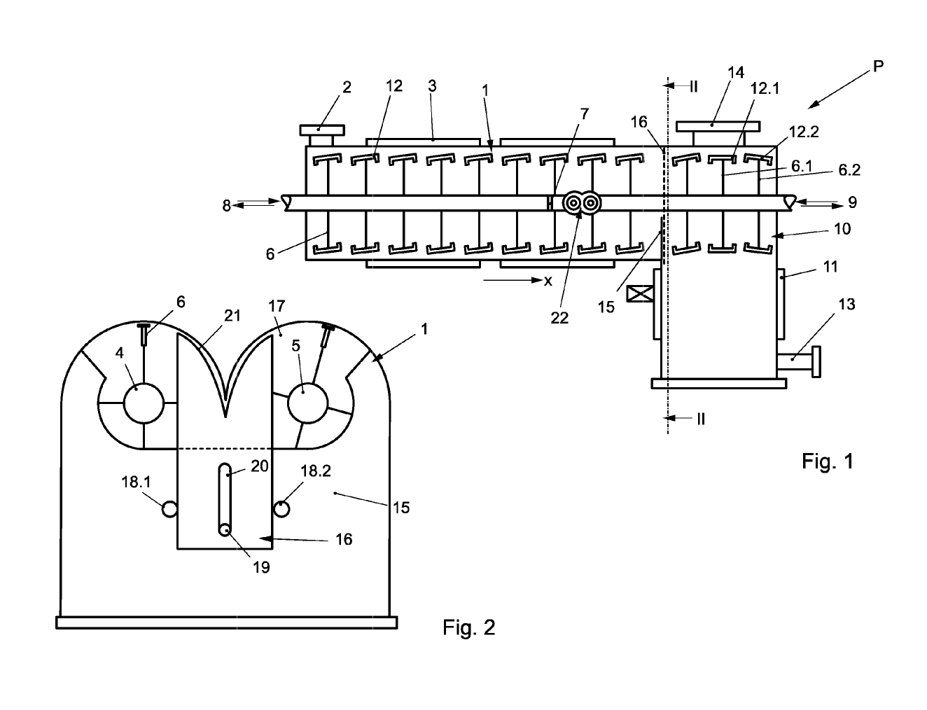

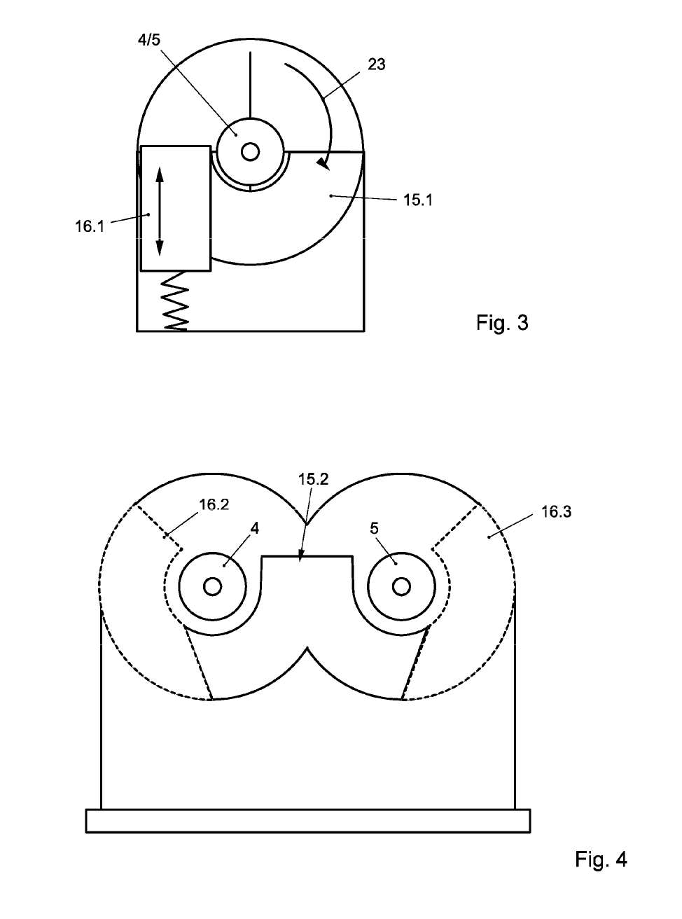

At the transition between housing 1 and output 10, an immovable weir 15 is provided and also a baffle plate 16, which is indicated in FIG. 1 by a dashed line. FIG. 2 shows that the immovable weir 15 closes off a large part of a housing cross section. A passage 17 for the product remains open only in the upper part. But even the cross section of passage 17 may also be reduced further by baffle plate 16, which in the embodiment shown is guided along weir 15. It is guided by lateral guide rollers 18.1 and 18.2 and a bolt 19, which engages in an elongated slot 20 in baffle plate 16. It may be clearly seen that at least a part 21 of the contour of baffle plate 16 matches the contour of housing 1.

A twin-screw infeed (EDS) 22 with N₂ flushing is also indicated on the side of the housing. This is used mainly to supply fines/powder.

The present invention functions as follows:

Any product on which mechanical, chemical and/or thermal processes are to be conducted in device P, is fed in through inlet 2. The product then enters the area of elements 6 with transport bars 12, which seize the product and advance it in transport direction x. As it is being transported, the product is kneaded, subjected to shearing forces and the like, and at the same time optionally admixed with initiators, solvents, catalysts, etc.

In the area of the first zone of the shaft, before wall 7, the product may be additionally heated not only by the heating medium in housing jacket 3, but also by the heating medium in the shaft. Then in the second area of the shaft, the product may be cooled as desired, which is also assisted by a medium at a controlled lower temperature or a refrigerant inside shaft 4 and in the second temperature controlled zone there.

Weir 15 causes the product to build up, so that in this area a very intensive mixing and kneading operation may be carried out before the product reaches output 10. Free passage 17 is adapted by adjustment of baffle plate 16 to constrict or enlarge said free passage 17 to a greater or lesser degree according to the requirements for the product.

Afterwards, the product enters output 10 where it is pressed into the lower area of output 10 by elements 6, 6.1 and 6.2, in such manner as to prevent any clogging. To this end, the interior of the output is preferably also coated with PTFE, which prevents the product from sticking almost entirely. The exhaust vapor extraction, which does not take place until the output, also ensures improved lubrication.

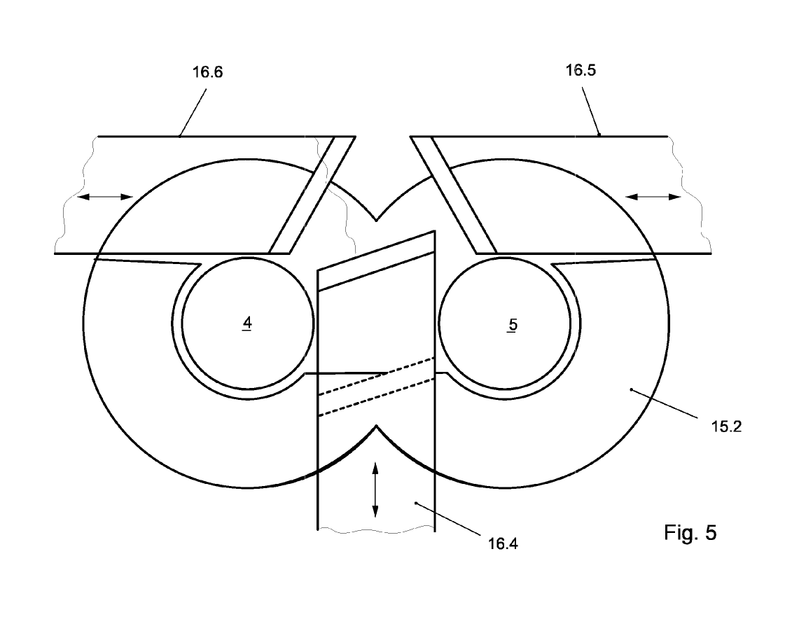

FIGS. 3 to 5 illustrate further options for altering the housing cross section. The example of FIG. 3 indicates that the inventive concept applies not only to double-shaft kneaders, but of course also to single-shaft kneaders. If more shafts than two are present, of course the inventive concept is equally applicable to these kneader mixers as well.

According to FIG. 3, an arrow 23 indicates that a weir 15.1 may also be displaceable about shaft 4/5. In this case, for example, a baffle plate 16.1 may also be disposed to the left of shaft 4/5. Of course, it may also be disposed above shaft 4/5. The options shown are intended purely for exemplary purposes.

According to FIG. 4, a further embodiment of an immovable position weir 15.2 is indicated, which weir also partially surrounds shaft 4 or 5. Semicircular baffle plates 16.2 and 16.3 may be provided before or after the weir, preferably so as to be rotatable about shaft 4/5. Said plates are indicated by dashed lines.

According to FIG. 5, again an immovable position weir 15.2 is provided; the cross section of the remaining free spaces in the housing may be modified by various sword-like baffle plates 16.4 to 16.6.

The absence of any dome/connecting element between the inlet and the output makes it possible for the machine to operate with a controlled high fill level. This is particularly important for comminuting possible lumps. This operating method is also referred to as a “lump free process”.

1-16. (canceled)

17. A device for implementing mechanical, chemical and/or thermal processes of a product that is located in a housing, comprising a housing (1) having mixing, cleaning and transport elements (6) on at least one shaft (4, 5), wherein the product is transported via the elements (6) from an inlet (2) to an output (10), the housing (1) has a cross section and is provided with both an immovable weir (15) and a baffle plate (16-16.6) which is able to change the housing (1) cross section.

18. The device as claimed in claim 17, wherein the baffle plate (16-16.6) is arranged at a transition between the housing (1) and the output (10).

19. The device as claimed in claim 18, wherein at least a part (21) of the baffle plate (16) is adapted to the cross section of the housing (1).

20. The device as claimed in claim 18, wherein the baffle plate (16-16.6) is controllable from outside the housing in such a manner as to adjust throughput rate.

21. The device as claimed in claim 20, wherein the baffle plate is designed such that an adjustment of the baffle plate (16-16.6) can take place during the process.

22. The device as claimed in claim 17, including at least one apparatus (22) for introducing fines/powder or additives to the housing (1).

23. The device as claimed in claim 22, wherein the apparatus (22) for introducing fines/powder is one of a single-screw conveyor and a twin-screw infeed (EDS) with N₂ flushing.
